(19) United States
(12) Patent Application Publication
(10) Pub. No.: US 2025/0275663 A1
(43) Pub. Date: Sep. 4, 2025

(54) SYNTHETIC SPONGE AND USE THEREOF AS A DISH SCRUBBER

(71) Applicant: Dotti Inc., Toronto (CA)

(72) Inventors: Rachel GARBUTT, Toronto (CA); Amanda RIVA, Toronto (CA)

(73) Assignee: Dotti Inc., Toronto (CA)

(21) Appl. No.: 18/591,192

(22) Filed: Feb. 29, 2024

(51) Int. Cl. A47L 13/16; C08J 9/00; C08L 83/04

(52) U.S. Cl. CPC A47L 13/16; C08J 9/0061; C08L 83/04; C08J 2383/04; C08J 2475/04

(57) ABSTRACT

A synthetic sponge comprising a body made of a silicone-based foam, the foam comprising between about 50 wt % and 90 wt % silicone material and between about 10 wt % and 50 wt % polyurethane sponge. A method of manufacturing a synthetic sponge, comprising mixing silicone material and polyurethane sponge precursor, obtaining a cool the mixture, infusing the mixture with gas and bursting the mixture to form the synthetic sponge. The silicone may be food-grade. The synthetic sponge can be used to make dish scrubbers. Hygiene, durability and cleaning of dish scrubbers are improved.

### FIELD OF THE INVENTION

The invention relates to manufacturing of a synthetic sponge and its use as a dish and surface scrubber.

### BACKGROUND OF THE INVENTION

Dish scrubbers are present in most households and are used on an almost daily basis. These are typically made of a spongious material but not of silicone and polyurethane. Examples of existing sponges are illustrated in US design patent U.S. Design 571,515, US patent publication US 2022/0142446 and Korean patent publication KR 10-2020-0145577.

Current scrubbers and/or sponges often retain moisture and food debris and are consequently difficult to clean. This also results in bacterial proliferation, which causes the scrubbers to rot, to smell poorly and/or to spread proliferating bacteria in the kitchen area. Therefore, it is currently recommended to replace dish scrubbers and/or kitchen sponges approximately weekly or bi-weekly, contributing to increased household waste.

Also, common scrubbers are generally rectangular, which is not ideal for having a good grip on them and for cleaning rounded pans and pots.

Accordingly, there is a need for a more durable sponge material that can serve as a dish scrubber.

There is a need for more convenient and safer dish scrubbers.

There is also a need for a sponge material and dish scrubbers made therefrom that comprises a food-grade silicone material and polyurethane.

The principles of the invention disclosed herein address these needs and other needs as it will be apparent from the review of the disclosure and description of the features of the invention hereinafter.

### BRIEF SUMMARY OF THE INVENTION

According to a broad aspect, a synthetic sponge comprises a body made of a silicone-based foam, the silicone-based foam comprising between about 50 wt-% and about 90 wt-% of a silicone material and between about 10 wt-% and about 50 wt-% polyurethane sponge.

In embodiments, the silicone-based foam comprises about 70 wt-% silicone. In embodiments, the silicone-based foam comprises about 30 wt-% polyurethane sponge. In embodiments, the silicone material is food-grade.

In embodiments the synthetic sponge has substantially an hourglass shape. In embodiments, the synthetic sponge has a substantially circular horizontal cross-section. In embodiments, the synthetic sponge has a diameter between 5 and 15 cm. In embodiments, the diameter is between 5 and 10 cm.

In embodiments, the body defines a recess along a perimeter of the body. In embodiments, the body defines a top portion and a bottom portion, the top portion and the bottom portion being substantially equally sized, and the recess is located substantially between the top portion and the bottom portion. In embodiments, the recess has a maximum depth between 0.5 mm and 12 mm or between 1 mm and 8 mm. In embodiments, the recess has a maximum depth of about 5 mm. In embodiments, the recess is substantially triangular. In embodiments, the recess is configured to receive an elastic band therein.

In embodiments, the silicone-based foam is one of a closed-cell foam and an open-cell foam. In embodiments, the silicone-based foam is an open-cell foam.

In embodiments, the synthetic sponge is dishwasher-safe. In embodiments, the synthetic sponge further comprises an antibacterial. In embodiments, the synthetic sponge comprises component(s) that prevents, or at least reduces, bacterial proliferation.

In embodiments, the synthetic sponge further comprises at least one of: an abrasive surface comprising an abrasive material extending over at least a portion of the body, one or more antibacterial agents, one or more UV agents and one or more colouring agents.

According to a broad aspect, a dish scrubber comprises a body made of a silicone-based foam comprising about 70 wt-% of a food-grade silicone and about 30 wt-% of a polyurethane sponge, the body having a circular horizontal cross-section and an hourglass shape, the body defining a recess along a circumference at a midpoint on a vertical axis, and further comprising an elastic band made of silicone rubber surrounding the body substantially at the midpoint.

According to a broad aspect, a method of manufacturing a synthetic sponge comprises preparing a mixture of a silicone material and a polyurethane sponge precursor, obtaining a cool mixture, infusing the mixture with a high-pressure gas to diffuse at least a portion of the high-pressure gas through the mixture, thereby obtaining an infused mixture, bursting the infused mixture to obtain the synthetic sponge.

In embodiments, the mixture comprises between about 50 wt-% and about 90 wt-% silicone material and between about 10 wt-% and about 50 wt-% polyurethane sponge precursor. In embodiments, the mixture comprises about 70 wt-% silicone material. In embodiments, the mixture comprises about 30 wt-% polyurethane sponge precursor. In embodiments, the silicone material is food-grade.

In embodiments, the preparing comprises mixing the silicone material and the polyurethane sponge precursor at a temperature from about 10° C. to about 150° C. In embodiments, the preparing comprises mixing the silicone material and the polyurethane sponge precursor at a temperature from about 80° C. to about 130° C.

In embodiments, the infusing is carried out between about 20 minutes and about 72 hours. In embodiments, the infusing is carried out between about 1 hour and about 24 hours. In embodiments, the infusing is carried out for about 6 hours. In embodiments, the infusing is carried out at a pressure between 1 bar and 10 bar. In embodiments, the infusing is carried out at a temperature 5° C. and 50° C. In embodiments, the high-pressure gas is air.

According to a broad aspect, a method of manufacturing a dish scrubber comprises preparing a synthetic sponge as described above, cutting out a shape from the synthetic sponge and shaving the shape to form the dish scrubber.

In embodiments, the method further comprises forming a recess along a perimeter of the dish scrubber. In embodiments, the method further comprises placing, substantially over the recess, an elastic band configured to engage at least a portion of the recess.

According to a broad aspect, the use of a mixture of silicone and polyurethane sponge to manufacture a synthetic sponge and/or a dish scrubber is provided.

Additional aspects, advantages and features of the present invention will become more apparent upon reading of the following non-restrictive description of preferred embodiments which are exemplary and should not be interpreted as limiting the scope of the invention.

### BRIEF DESCRIPTION OF THE DRAWINGS

For the invention to be readily understood, embodiments of the invention are illustrated by way of example in the accompanying drawings.

FIG. 1 is a top perspective view of a dish scrubber according to the principles disclosed herein.

FIG. 2 is a side view of a dish scrubber according to the principles disclosed herein.

FIG. 3 is a cross-section of a dish scrubber according to the principles disclosed herein, taken along lines A-A of FIG. 2.

FIG. 4 is top perspective view of a dish scrubber comprising a central rubber band, according to the principles disclosed herein.

FIG. 5 is a flowchart for a process for manufacturing a synthetic sponge material according to the principles disclosed herein.

Further details of the invention and its advantages will be apparent from the detailed description included below.

### DETAILED DESCRIPTION OF EMBODIMENTS

In the following description of the embodiments, references to the accompanying drawings are illustrations of an example by which the invention may be practised. It will be understood that other embodiments may be made without departing from the scope of the invention disclosed. Unless defined otherwise, all technical and scientific terms used herein have the same meaning as commonly understood by one of ordinary skill in the art to which the invention belongs.

In the following description, the term “about” encompasses reasonable variations of the value as would be understood by the skilled person. In particular, the term “about” is not limited to reasonable measurement error alone and encompasses those variations, up to and including 10% of the value, that would, as appreciated by a skilled person, provide for a substantially similar product and/or process operating in substantially the same way as described.

Headings are included herein for reference and to aid in locating certain sections. These headings are not intended to limit the scope of the concepts described therein, and these concepts may have applicability in other sections throughout the entire specification. Thus, the present invention is not intended to be limited to the embodiments shown herein but is to be accorded the widest scope consistent with the principles and novel features disclosed herein.

The singular forms “a”, “an” and “the” include corresponding plural references unless the context clearly dictates otherwise. Thus, for example, reference to “a compound” includes one or more of such compounds and reference to “the method” includes reference to equivalent steps and methods known to those of ordinary skill in the art that could be modified or substituted for the methods described herein.

Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in any specific examples are reported as precisely as possible. Any numerical value, however, inherently contains certain errors resulting from variations in experiments, testing measurements, statistical analyses, and such.

The present description generally provides a synthetic sponge and methods of manufacturing and using the synthetic sponge. Embodiments presented in this description and the accompanying drawings directed to dish scrubbers are exemplary only. It is understood that the synthetic sponge presented herein may be put to other uses, including but not limited to personal care, household and/or industrial cleaning without departing from the present teachings.

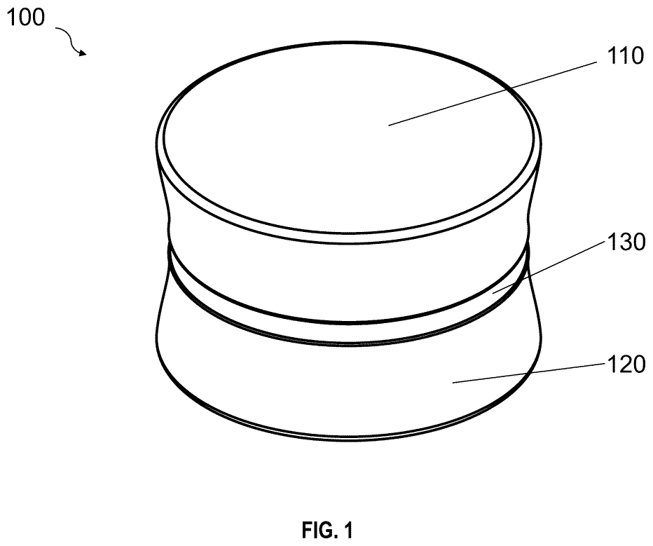

Referring to FIG. 1, a dish scrubber 100 according to the principles of the present invention generally comprises a body made from a porous and optionally resilient material. The material may be a foam, a sponge, or other appropriate material as apparent to a skilled person. It is understood that the terms “foam” and “sponge” may be used interchangeably in the context of the present description without departing from or limiting the principles disclosed herein.

For example, the body of the scrubber 100 may be made of a polymeric foam, a silicone-based foam, other foams and/or porous or sponge-like materials as appropriate. It is understood that the foam and/or sponge materials disclosed herein may be closed-cell, open-cell, or combinations thereof.

The dish scrubber 100 may generally comprise a top portion 110 and a bottom portion 120. The top portion 110 and the bottom portion 120 may be formed integrally with each other, for example when the body of the scrubber 100 is cut out or otherwise formed from a single foam object. For example, the body of the scrubber 100 may be cut out of a prepared foam or sponge sheet, and thus the top and bottom portions would be integrally formed. For example, the top portion and the bottom portion may be manufactured separately and bonded together in an acceptable way, including but not limited to adhesion, thermal bonding, and the like.

In preferred embodiments, the body of the dish scrubber 100 is made from a silicone-based material, for example a silicone-based foam comprising between about 50 wt-% and about 90 wt-% of a silicone material. In embodiments, the silicone material is food-grade.

In the context of the present description, “food-grade” denotes a material suitable for use in contact with food as is generally understood. In general, a food-grade material contains substantially no additives, binders or other components that are unsuitable for use with food preparation and/or for uses where the material may come into contact with food, water for consumption, cookware and/or dishware.

The silicone-based foam may also comprise a polymer suitable for foam and/or sponge formation, for example polyurethane or other polymeric foam and/or sponge materials. The silicone-based foam may comprise from about 10 wt-% to about 50 wt-% polymer, for example between about 10 wt-% and about 50 wt-% polyurethane sponge. For example, the silicone-based foam may comprise between about 60 wt-% and about 80 wt-% food-grade silicone material or between 65 wt-% and 75 wt-% food-grade silicone material. The silicone-based foam may comprise between about 20 wt-% and about 40 wt-% polyurethane sponge, or between about 25 wt-% and about 35 wt-% polyurethane sponge. In embodiments, the body of the dish scrubber 100 is made of a silicone-based foam comprising about 70 wt-% food-grade silicone material and about 30 wt-% polyurethane sponge.

The synthetic sponge may also comprise one or more additives such antibacterial agents, coloring agents and UV agents for reducing degradation due to UV exposure. For instance, providing coloring agents is useful to obtain a synthetic sponge and scrubbers having a color attractive to consumers (e.g., black, green, pink, yellow, red, etc.). Providing antibacterial agents may be useful to prevent, or at least reduce, growth of bacteria within the sponge. The antibacterial agent may be provided as a stand-alone compound, for example an antibiotic, a detergent, a disinfectant, etc. or as a composition. In one embodiment, the additives are embedded in the synthetic sponge, for example by being provided thereto during mixing of compounds during preparation or during forming of the sponge. In another embodiment, the additives are added to the already formed synthetic sponge, and optionally immobilized thereon or bonded thereto using acceptable immobilization and/or bonding techniques including but not limited to chemical bonding, electrostatic bonding, and others.

In embodiments, the dish scrubber 100 has a shape and a size adapted for a proper fit in a user's hand, e.g., when scrubbing dishes. While the embodiments shown in the drawings have a generally circular horizontal cross-section, it is understood that other shapes of the dish scrubber 100 are possible without departing from the principles disclosed herein.

For example, the dish scrubber 100 may have a circular horizontal cross-section and have a diameter suitable for grasping and/or holding by a user. For example, the dish scrubber 100 may have a diameter between about 5 cm and about 15 cm. In embodiments, the dish scrubber 100 may have a diameter between about 5 and about 10 cm. Other sizes and configurations are possible. For example, the dish scrubber 100 may have a quadrilateral shape and have at least one length of at least one axis being suitable for grasping and/or holding by a user. For example, the dish scrubber 100 may be spherical and have a diameter suitable for grasping and/or holding by a user. It is understood that the dimensions as described above allow for grasping and/or holding of the dish scrubber 100 as well as providing at least a portion of the body of the dish scrubber 100 for scrubbing dishes therewith.

In embodiments, the body of the dish scrubber 100 comprises a recess 130. In accordance with the principles of the present invention, the recess may be helpful for having a better hand grip of the scrubber. It is understood that the term “recess” includes but is not limited to notches, indentations, grooves, and other terms generally denoting a depression in a surface.

The recess 130 may be defined along a perimeter of the dish scrubber 100. For example, the dish scrubber 100 may have a circular horizontal cross-section and the recess 130 may be defined along the circumference of the dish scrubber 100. In embodiments, the recess 130 may be located substantially half-way along a vertical axis of the dish scrubber 100. In embodiments, the recess 130 is defined in a body comprising a top portion 110 and a bottom portion 120 is located substantially at the nexus of these two portions. For example, the top portion 110 may define an oblique or arcuate portion along a lower edge, the bottom portion 120 may define an oblique or arcuate portion along an upper edge, and the top portion 110 and the bottom portion 120 may be assembled together using acceptable joining, attaching, securing and/or bonding techniques, thereby forming a body defining a recess 130.

The recess 130 may have a maximum depth of between 0.5 mm and 12 mm. In embodiments, the recess has a maximum depth between 1 mm and 8 mm, for example about 5 mm.

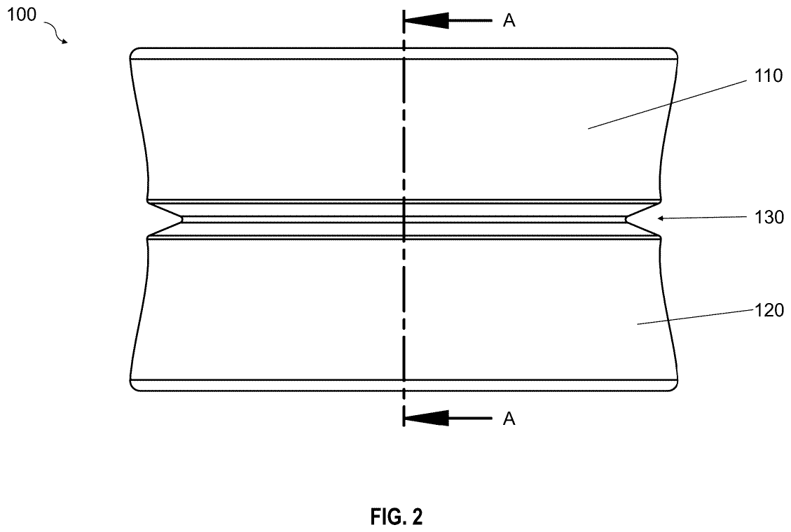

Referring now to FIG. 2, a dish scrubber 100 may generally be shaped as an hourglass. In this embodiment, the top portion 110 and the bottom portion 120 have oblique outer faces inclined at least partially towards a center of the body of the dish scrubber 100. It will be understood that the body of the dish scrubber 100 may have other shapes, for example cylindrical, cubic, spherical, or other appropriate shapes. When the dish scrubber 100 has a generally hourglass shape, the recess 130 may be located substantially at the narrowing point of said hourglass shape.

It is also understood that the body of the dish scrubber 100 may be symmetrical and/or asymmetrical in any plane. For example, the top portion 110 may be larger or smaller than the bottom portion 120, the top portion 110 and the bottom portion 120 may have different shapes and/or define other features of the body without departing from the present teachings.

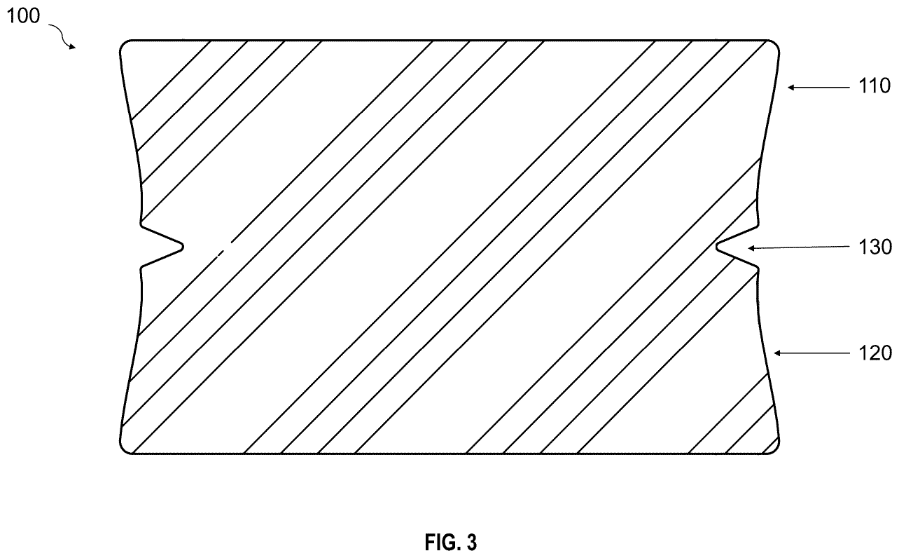

Referring now to FIG. 3, a section along the A-A axis of FIG. 2 is shown. It is understood that the body of the dish scrubber 100 is generally porous and/or spongy, accordingly defining any one or more of cells, pores, filaments, films, and other elements characteristic of a generally sponge-like material. As shown in FIG. 3, the body of the dish scrubber 100 may generally have an hourglass shape where two opposite sides of a substantially square or rectangular cross-section are at least partially inwardly arcuate, and further defining a recess at the apices of the arches. The recess 130 may be substantially triangular in shape. It is understood that other recess shapes are possible, for example arcuate, square, and other appropriate shapes.

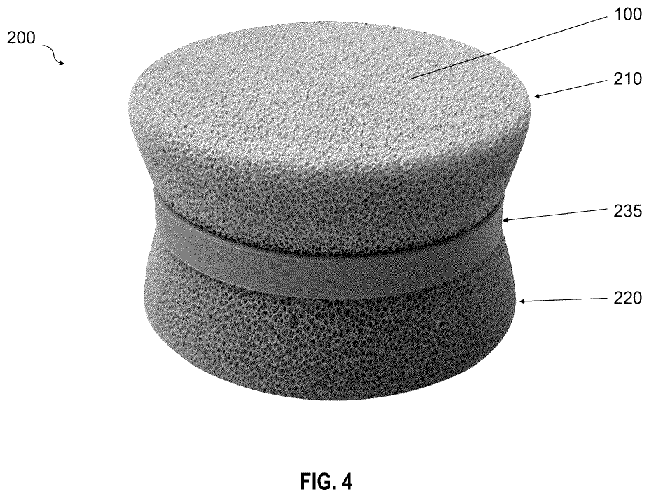

Referring now to FIG. 4, an exemplary dish scrubber 200 further comprising an elastic band is shown. The dish scrubber 200 comprises a dish scrubber, for example but not limited to the dish scrubber 100, and a band 235 made of a resilient material. The band 235 may be made of rubber, of a silicone-based material, for example of silicone rubber, for example food-grade silicone, and/or made of any other appropriate material. The band 235 may be produced according to appropriate techniques for forming, casting, shaping and/or curing resilient and/or elastic materials. In embodiments, the band 235 is a silicone rubber band shaped with compression molding.

In embodiments, the dish scrubber 200 comprises a recess (not shown in FIG. 4 as it is located under the band 235), the recess being configured to receive the band 235 therein. For example, the recess may have a substantially triangular shape and the band 235 may comprise one or more protrusions on an inner face of the band, the protrusions configured to fit in the recess, for example to matingly engage the recess of the body of the dish scrubber of the dish scrubber 200. In embodiments, the recess may be configured to receive a band 235 without corresponding protrusions. For example, the body of the dish scrubber 200 may be at least partially resilient and/or elastic and/or deformable, and the recess may be configured to receive the band 235 by allowing at least a partial deformation of the recess to substantially conform to at least a part of the shape of the band 235. Other configurations are possible.

Preferably, the dish scrubber 100 and/or 200 are configured to be dishwasher-safe. Accordingly, the body of the dish scrubber 100 and/or 200, as well as the optional band 235 may comprise dishwasher-safe materials according to accepted industry standards. The dish scrubber 100 and/or 200, and optionally the band 235 may comprise antibacterial agent(s) as defined hereinbefore.

The dish scrubber 100 and/or 200 according to the principles of the present invention may have antibacterial properties and/or impede and/or reduce bacterial proliferation compared to conventional dish scrubbers and/or dish sponges. For example, the dish scrubber 100 and/or 200 may reduce bacterial proliferation by between about 5% and 90% compared to conventional dish scrubbers and/or dish sponges. For example, the bacterial proliferation may be reduced by between about 20% and about 80%, between about 30% and about 70%. Without being bound by any particular theory, the dish scrubber 100 and/or 200 provides a silicone environment that is more resistant to bacterial proliferation than conventional dish scrubbers. For example, the dish scrubber 100 and/or 200 may present smoother surfaces facilitating fluid and debris evacuation from the scrubber. Additionally, lack of fluid absorption into the body of the scrubber 100 and/or 200 reduces dampness within the scrubber, thereby making the environment less prone to the proliferation of bacteria and/or molds. Additional antibacterial agents may be added to increase the proliferation resistance.

The dish scrubber 100 and/or 200 may comprise further components or features suitable for dish scrubbing and/or other cleaning tasks. For example, the dish scrubber 100 and/or 200 may comprise one or more exterior abrasive surfaces, for example a scouring portion, for example a portion comprising a steel sponge and/or a plastic and/or a polymeric abrasive surface. The abrasive portion may extend over at least a portion of the body of the dish scrubber 100 and/or 200, for example over a top face, a bottom face, or portions thereof. Those skilled in the art will readily understand that configurations are possible.

While the embodiments described above are generally configured to be grasped by a user for scrubbing dishes, it is understood that the scrubber 100 and/or 200 can have other uses without departing from the principles above. For example, the scrubber 100 and/or 200 may be smaller, for example by having a smaller diameter or a smaller height, for cleaning small spaces. The scrubber 100 and/or 200 may be configured for being placed on a member such as a handle or a stick for use as a scrub brush.

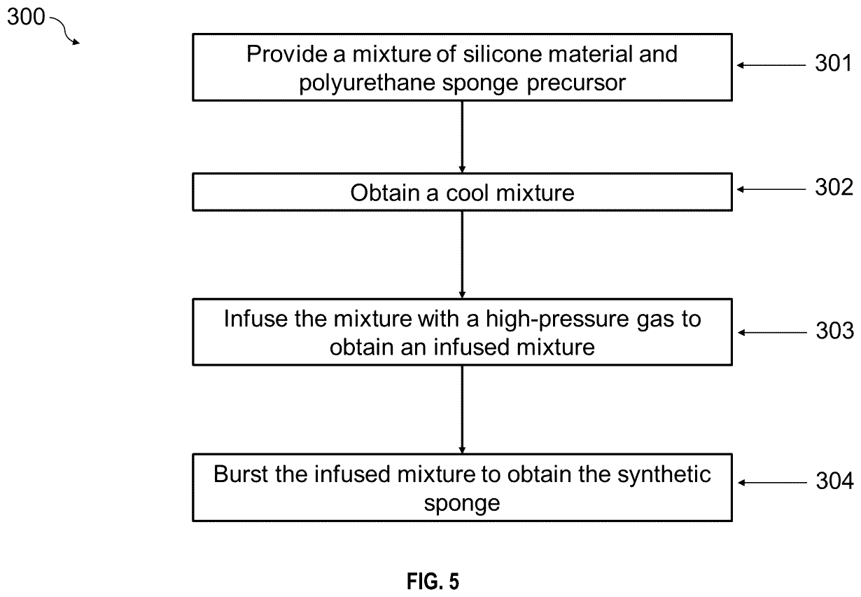

Referring now to FIG. 5, an exemplary process 300 for manufacturing a synthetic sponge is presented. The synthetic sponge may be the silicone-based sponge described above.

In one embodiment, the process 300 comprises preparing a mixture of a silicone material and a polyurethane sponge precursor (301). For example, the mixture comprises between about 50 wt-% and about 95 wt-% silicone material and between about 10 wt-% and about 50 wt-% of polyurethane sponge precursor. In embodiments, the mixture comprises about 70 wt-% silicone material. In embodiments, the mixture comprises about 30 wt-% polyurethane sponge precursor. It will be understood that other polymeric and/or synthetic sponge precursors are acceptable and may be used without departing from the present teachings.

The mixture may comprise additional components such as foaming agents, binders, activating agents and reagents suitable for forming a foam and/or sponge material. The mixture may be prepared at an appropriate temperature, for example a temperature suitable for maintaining the silicone and the polyurethane sponge precursor in a sufficiently fluid state to enable mixing of the mixture. It is understood that some synthetic foam preparations, for example some preparations of polymers and activators and/or foaming agents, may entail one or more exothermic reactions, raising the temperature of the mixture. It is understood that appropriate combinations of externally-provided heat, for example heating jackets and/or heaters, and endogenous heat sources, for example an exothermic reaction, will be apparent to a skilled person. In embodiments, the mixture, or at least a portion thereof, is prepared at a temperature from about 10° C. to about 150° C., for example at a temperature from about 80° C. to about 130° C. In embodiments, the mixture, or at least a portion thereof, is prepared at room temperature, for example when the silicone and the polyurethane sponge precursor are acceptably fluid at room temperature.

In embodiments, the silicone material is food-grade as defined above.

The process comprises obtaining a cool mixture (302). Whenever required the mixture from step (301) may be cooled at an appropriate temperature. For example, when the silicone material and the polyurethane sponge precursor are acceptably fluid at room temperature, the preparing (301) may be carried out at room temperature and the mixture may be cooled to below room temperature at (302). The mixture may be heated during the preparing (301) to allow or to improve mixing of the silicone material and the polyurethane sponge precursor and obtaining a cool mixture (302) accordingly comprises cooling the mixture to a temperature below the preparing temperature. Appropriate processing conditions will be apparent to the skilled person.

The cooling may be active, for example by providing cold air or a cold surface, or passive, for example by allowing the mixture to cool. As the mixture cools, the fluidity and/or malleability of the mixture may decrease to reach a suitably fluid or malleable state that may be shaped into a desired shape. For example, the mixture may be poured, pressed or otherwise provided into a mold for forming an appropriate shape therefrom. For example, the cooled mixture may be shaped into a sheet. The mixture may be shaped into a suitable shape for further processing, for example into a cylinder, into a prism, into a cube, or into any other appropriate shape.

The process 300 also comprises infusing the mixture in a high-pressure gas to diffuse at least a portion of the high-pressure gas through the cool mixture (303). The infusing may be carried out in an appropriate pressurizable vessel, for example a water chamber, a pressure chamber, or another vessel for a similar function.

The infusing may comprise providing a pressurized gas, to a pressurizable vessel with the cooled and optionally formed mixture provided therein. Suitable gases may include pressurized air, nitrogen, carbon dioxide, a noble gas, other gases and mixtures thereof. It is understood that the mixture may be provided to the pressurizable vessel without forming, for example the mixture may be provided in a substantially fluid and/or malleable form into a pressurizable vessel or a pressurizable mold, and allowed to settle therein without further forming or with minimal forming, for example by tamping or otherwise evening out asperities or other uneven surface features.

During infusing, the gas is generally allowed to permeate the mixture in order to create bubbles or pockets of the gas in the material during infusion.

The infusion step may be carried out between about 20 minutes and about 72 hours. In embodiments, the infusion step may be carried out between about 1 hour and about 24 hours. In embodiments, the infusion is carried out for about 6 hours

The infusing step may be carried out at a temperature appropriate for allowing gas permeation into the prepared silicone. For example, the temperature may be slightly below the preparation temperature as described above, or substantially cooler, for example from about 5° C. to about 50° C.

The infusing step may comprise subjecting the mixture to a gas pressure between about 1 bar and about 10 bar.

It is understood that infusion conditions may be chosen according to the characteristics of the synthetic sponge being manufactured. For example, longer infusion times and/or higher gas pressures may be used to increase the overall quantity of infused gas. Temperature conditions for the infusing step may also be varied to accelerate or decelerate the infusion process. For example, in a non-limiting embodiment, the infusion may be carried out above room temperature to speed up gas permeation. Other manufacturing conditions are possible.

The infusion step produces an infused mixture. The process comprises bursting the infused mixture to obtain the synthetic sponge (304). It is understood that “bursting” may comprise releasing the pressure in the pressurizable vessel or mold, thereby causing the compressed infused gas to expand, thereby forming gas pockets, gas cells, pores and/or open cells in the infused mixture, obtaining a synthetic sponge. It is understood that other methods and compounds causing the infused mixture to form a synthetic sponge may be used. For example, it may be conceivable to use activating agents, foaming agents and/or other reagents capable of improving and/or increasing foaming, capable of improving cell formation and/or capable of solidifying the synthetic sponge.

A method of manufacturing a dish scrubber is also presented. The method comprises obtaining a synthetic sponge material as described above, and further comprises obtaining a dish scrubber therefrom by cutting out at least a portion of the synthetic sponge material and machining said portion to obtain the dish scrubber. The portion may be a shape, for example a generally cylindrical shape that is cut out from a synthetic sponge sheet. The machining may comprise an appropriate technique for conferring a predetermined final shape to the cut-out portion. For example, a generally cylindrical cut-out portion may be shaped to obtain an hourglass shape. Other machining techniques and final shapes and/or forms are possible. The dish scrubber may be machined to a predetermined size, shape, smoothness and/or to other predetermined characteristics.

The method of manufacturing a dish scrubber may further comprise machining a recess into the body of the dish scrubber, for example a recess as described above. The machining may be any appropriate shaping and/or processing technique, for example shaving, cutting, heat-forming, and other techniques that will be apparent to a skilled person. The sheet, the cut-out portion and/or the final shaped product may be dried.

The method of manufacturing a dish scrubber may further comprise providing a band comprising a resilient and/or elastic material, for example an elastic band, and placing said elastic band around the dish scrubber. The band may be similar to the band 235 as described above. For example, the band may be a silicone rubber band and the recess machined into the body of the dish scrubber may be configured to receive said band therein.

It is understood that other methods of forming a synthetic porous or sponge-like structure comprising silicone and a polyurethane sponge are possible. For example, the synthetic sponge may be produced by foaming a mixture comprising silicone and a polyurethane sponge precursor in a low pressure environment, causing gases dissolved in the mixture to expand. The pressure may be low, such as about 0.5 kPa absolute. The synthetic sponge may be produced by providing a mixture comprising silicone, polyurethane sponge precursor and one or more foaming agents. It is understood that ambient pressure or reduced pressure may be used to facilitate foaming and expansion.

The average pore size of the sponge may be modulated by adjusting the pressure during the forming stage. For example, a pressure slightly above ambient pressure during a foaming phase may result in a reduced average pore diameter compared to foaming at ambient pressure.

The synthetic sponge may be produced by mixing a selectively soluble component with the silicone and the polyurethane sponge precursor such that, when the prepared mixture is sufficiently solid, the selectively soluble component may be dissolved and eluted by providing a solvent that does not dissolve the silicone and the polyurethane sponge, leaving open and closed sponge cells and channels in the sponge body. For example, the dissolving step may be carried out over the course of about 24 hours. It is understood that such manufacturing techniques may be combined. For example, both low-pressure foaming and selective dissolution may be used to provide a desired porosity and pore size for the synthetic sponge.

The principles of the present invention provide one or more advantages. According to an advantage, the dish scrubber is dishwasher-safe, allowing a user to conveniently and reliably clean the dish scrubber at high temperatures in a dishwasher. Overall aesthetics of a kitchen area may thus be improved, for example by improving the cleanliness, appearance and/or smell of a dish scrubber situated therein.

According to an advantage, the dish scrubber has a low bacterial proliferation. In embodiments, the materials composing the dish scrubber according to the principles of the present invention are selected to facilitate the cleaning of the dish scrubber, reduce water and/or debris retention, thus making conditions less favourable for bacteria to proliferate.

According to another advantage, the dish scrubber is durable. In embodiments, the dish scrubber according to the principles of the present invention exhibits longer durability according to a synergistic effect of the materials composing its body. The dish scrubber may also be less prone to tearing, extension, ripping and/or other degradation due to an additional structural solidity effect provided by an elastic band according to the principles disclosed herein.

Those skilled in the art will recognize, or be able to ascertain, using no more than routine experimentation, numerous equivalents to the specific procedures, embodiments, claims, and examples described herein. Such equivalents are considered to be within the scope of this invention and covered by the claims appended hereto. Any examples used to illustrate the present invention should not be construed as further or specifically limiting.

It is understood that the examples and embodiments described herein are for illustrative purposes only and that various modifications or changes in light thereof will be suggested to persons skilled in the art and are to be included within the present invention and scope of the appended claims.

1. A synthetic sponge, comprising a body made of a silicone-based foam, wherein the silicone-based foam comprises about 50 wt-% to about 90 wt-% of a silicone material and about 10 wt-% to about 50 wt-% polyurethane sponge.

2. The synthetic sponge according to claim 1, wherein the silicone-based foam comprises at least one of: about 70 wt-% of a silicone material and about 30 wt-% polyurethane sponge.

3. The synthetic sponge according to claim 1, wherein the silicone material is food-grade.

4. The synthetic sponge according to claim 1, wherein the synthetic sponge has at least one of: a substantially hourglass shape and a diameter of about 5 cm to about 10 cm.

5. The synthetic sponge according to claim 1, wherein the body defines a recess along a perimeter of the body and wherein at least one of:
the body defines a top portion and a bottom portion, the top portion and the bottom portion being substantially equally sized, and the recess is located substantially between the top portion and the bottom portion;
the recess has a maximum depth of about 0.5 mm to about 12 mm;
the recess is substantially triangular; and
the recess is configured to receive an elastic band therein.

6. The synthetic sponge according to claim 1, further comprising an elastic band surrounding said body.

7. The synthetic sponge according to claim 1, wherein the synthetic sponge is dishwasher-safe.

8. The synthetic sponge according to claim 1, further comprising at least one of: an abrasive surface comprising an abrasive material extending over at least an exterior surface of the body; one or more antibacterial agents; one or more UV agents; and one or more colouring agents.

9. A dish scrubber comprising the synthetic sponge according to claim 1.

10. A dish scrubber comprising:
a body made of a silicone-based foam, wherein:
the silicone-based foam comprises about 70 wt-% of a food-grade silicone and about 30 wt-% of a polyurethane sponge;
the body has a circular horizontal cross-section and has an hourglass shape;
the body defines a recess along a circumference of the body at a midpoint on a vertical axis of the body; and
an elastic band made of silicone rubber surrounding the body substantially at the midpoint.

11. A method of manufacturing a synthetic sponge, comprising the steps of:
preparing a mixture comprising a silicone material and a polyurethane sponge precursor;
obtaining a cool mixture;
infusing the cool mixture with a high-pressure gas to diffuse at least a portion of the high-pressure gas through the mixture, thereby obtaining an infused mixture; and
bursting the infused mixture to obtain said synthetic sponge.

12. The method according to claim 11, wherein the mixture comprises at least one of:
about 50 wt-% to about 90 wt-% silicone material and about 10 wt-% to about 50 wt-% polyurethane sponge precursor;
about 70 wt-% silicone material; and
about 30 wt-% polyurethane sponge precursor.

13. The method according to claim 11, wherein at least one of steps of:
preparing comprises mixing the silicone material and the polyurethane sponge precursor at a temperature of about 10° C. to about 150° C.;
infusing is carried out at a temperature of about 5°° C. to about 50° C.;
infusing is carried out at a pressure of about 1 bar to about 10 bar; and
infusing is carried out for about 20 minutes to about 72 hours.

14. The method according to claim 13, wherein at least one of the steps of:
preparing comprises mixing the silicone material and the polyurethane sponge precursor at a temperature of about 80° C. to about 130° C.; and
infusing is carried out for about 6 hours.

15. The method according to claim 11, wherein the silicone material is food-grade.

16. The method according to claim 11, wherein the high-pressure gas is air.

17. A method of manufacturing a dish scrubber, comprising:
preparing a synthetic sponge according to the method of claim 11;
cutting out a shape from the synthetic sponge; and
shaving the shape to form the dish scrubber.

18. The method according to claim 17, further comprising forming a recess along a perimeter of the dish scrubber.

19. The method according to claim 18, further comprising placing, substantially over the recess, an elastic band configured to engage at least a portion of the recess.
